(19) United States
(12) Patent Application Publication
(10) Pub. No.: US 2003/0127539 A1
(43) Pub. Date: Jul. 10, 2003

(54) Injection device and method for injecting a fluid

(76) Inventors: Wolfgang Braun, Ditzingen (DE); Bernd Mahr, Plochingen (DE); Martin Kropp, Tamm (DE); Hans-Christoph Magel, Pfullingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,481

(22) PCT Filed: Jan. 12, 2001
(86) PCT No.: PCT/DE01/00098

(30) Foreign Application Priority Data
Jan. 20, 2000 (DE) 100 02 273.1

(51) Int. Cl. F02M 59/00

(52) U.S. Cl. 239/533.2

(57) ABSTRACT

An injection device with an injection nozzle (42), a pressure intensifier (12) for intensifying a primary pressure, a first valve device (32) for triggering the pressure intensifier (12), and an actuator for actuating the first valve device (32), wherein the pressure intensifier (12) is activated in a first state of the first valve device (32), the pressure intensifier (12) is deactivated in a second state of the first valve device (32), and a limitation of the through flow quantity to the injection nozzle (42) is provided. The invention also relates to a method, which makes advantageous use of the device according to the invention.

### PRIOR ART

The invention relates to an injection device, with an injection nozzle, a pressure intensifier for intensifying a primary pressure, a first valve device for triggering the pressure intensifier, and an actuating element for actuating the first valve device. The invention also relates to a method for injecting fluid, in which in a first phase, an injection takes place at a low pressure and in a second phase, an injection takes place at a high pressure.

A device and method of these generic types are known. A basic requirement for such a system is comprised in carrying out the fuel injection at the highest possible injection pressure. A high injection pressure has positive effects on the function of an engine; for example, pollutant emissions and fuel consumption are reduced. However, it can also be desirable to carry out an injection at low pressure with the same system. An injection of this kind at low pressure can be used, for example, for a preinjection, which serves, among other things, to reduce noise. The production of different pressures during an injection cycle can be used, for example, to produce an advantageous “boot” shape of the course of the injection pressure.

In order to achieve the high injection pressure, a pressure intensifier is provided, which uses a hydraulic transmission to convert a primary pressure, for example supplied from a pressure reservoir, into the desired high injection pressure. A suitable selection of the surfaces that are subjected to force and the countervailing forces of elastic means can therefore be used to adjust a suitable pressure intensification.

A pressure intensification of this generic type is particularly useful in connection with a common rail system. In “common rail” reservoir injection, the primary pressure generation and the injection are decoupled. The injection pressure is generated by a high-pressure pump and is placed in readiness for the injection in the “rail” (fuel reservoir). In principle, this permits a favorable course of injection to be produced because in particular, the injection pressure and injection quantity can be determined independently of each other for each operating point of the engine. However, the pressure in the common rail is currently limited to approx. 1600 bar, which makes it desirable to increase the pressure for emissions reasons. A pressure intensifier in combination with a common rail system could consequently provide particularly favorable results. However, in pressure-intensified common rail systems, additional valve devices must be provided to refill the different functional chambers of the pressure intensifier. According to prior art, the entire high-pressure chamber in the injector and in the pressure intensifier is pressure-relieved, which results in high pressure drop losses.

FIG. 5 shows a common rail system in which an injector or an injection nozzle 110 is coupled to a pressure intensifier 112. The pressure intensifier 112 is triggered by means of a 2/2-port directional-control valve 114, which controls the pressure in the chamber 134 so that relatively low pressure drop losses are produced in comparison to triggering by means of a 3/2-port directional-control valve. The hydraulic circuit depicted has a bypass path 116 in order to alternatively permit an injection with rail pressure or an injection with intensified pressure. The activation and deactivation of the pressure intensifier 112 occur through the opening and closing of the valve 114. However, it should be noted that with this system, rail pressure is continuously supplied to the injector 110 by means of the bypass path 116. A jamming of the injection nozzle needle or of the injector valve would therefore result in a continuous injection, which can end up destroying the engine. It is therefore desirable to produce a system with an inherent safety, which has a structurally established maximal injection quantity, i.e. an injection quantity, which cannot be exceeded in the event of damage to one of the system components.

For the sake of completeness, the other components of the system shown in FIG. 5 will now be described. For stroke control, a valve 118 communicates with a control chamber 122 of the injector 110 by means of an outlet throttle 120. The control chamber 122 also communicates with the fluid supply by means of an inlet throttle 124. The fluid is also supplied to the pressure chamber 126 of the injection nozzle 110. The fluid supply line 116 contains a check valve 128, which permits a fluid transport only in the direction of the injection nozzle 126. The pressure intensifier 112 has a low-pressure chamber 130, a high-pressure chamber 132, and a differential chamber 134. The differential chamber 134 communicates with the pressure reservoir (“rail”) 138 by means of a throttle 136, whereas the low-pressure chamber 130 and the high-pressure chamber 132 communicate with the pressure reservoir 138 directly or by means of the check valve 128. In a four-cylinder engine, the pressure reservoir 138 has connections to four injectors, which it supplies with the rail pressure. A supply line to the pressure reservoir 138, in which a pressure sensor and a control circuit are provided, leads from a fuel tank 140 by means of a quantity-controlled high-pressure pump 142.

### ADVANTAGES OF THE INVENTION

According to claim 1, the invention builds on the prior art in that the pressure intensifier is activated in a first state of the first valve device, that the pressure intensifier is deactivated in a second state of the first valve device, and that a limitation of the through flow quantity to the injection nozzle is provided. On the one hand, the invention permits a simple triggering of a pressure intensifier by means of a valve in which only slight pressure drop losses occur, and this is advantageously combined with a limitation of the through flow quantity to the injection nozzle. This consequently prevents a jamming of the nozzle needle or of the control valve of the injection nozzle from leading to a continuous injection and finally to a destruction of the engine.

Preferably, the pressure intensifier has a low-pressure chamber, a high-pressure chamber, and a differential chamber, in which the first valve device communicates with the differential chamber by means of a first connection, the first valve device communicates with a return system by means of a second connection, and the first valve device is open in the first state so that the differential chamber communicates with the return system. When the valve is closed, the piston of the pressure intensifier is consequently pressure balanced since the rail pressure prevails in the differential chamber. No pressure intensification occurs. However, if the valve is open, then this relieves the pressure in the differential chamber. As a result, the pressure intensifier is activated and an injection can take place at an increased pressure.

It is advantageous if the low-pressure chamber of the pressure intensifier communicates with the differential chamber of the pressure intensifier by means of a first throttle and a second valve device; the first throttle and the second valve device are disposed in parallel, the second valve device unblocks the flow of a fluid from the differential chamber to the low-pressure chamber and the second valve device shuts off the flow of a fluid from the low-pressure chamber to the differential chamber. The second valve device consequently makes it possible for the differential chamber to be unpressurized when the first valve device is open so that the pressure intensifier can be activated. The second valve unit prevents an excess pressure from building up in the differential chamber in comparison to the low-pressure chamber. The differential chamber is filled by means of the throttle when the pressure intensifier is reset.

Preferably, the second valve device is a check valve. Such a valve is suitable for performing the above-described functions of the second valve device.

Preferably, the low-pressure chamber of the pressure intensifier communicates with the high-pressure chamber of the pressure intensifier by means of a second throttle and a check valve; the check valve unblocks the flow of a fluid from the low-pressure chamber to the high-pressure chamber and the check valve shuts off the flow of a fluid from the high-pressure chamber to the low-pressure chamber. The check valve is useful in preventing the pressure in the high-pressure chamber from being relieved in the direction of the low-pressure chamber. The throttle assures that the connection has a sufficiently small through flow cross section so that it cannot serve as a bypass for an injection. By means of this measure, in the event of an undesirable overflow in the injector, e.g. due to needle jamming, a pressure difference is generated between the low-pressure chamber and the high-pressure chamber of the pressure intensifier, as a result of which a pressure intensifier piston assumes its maximal stroke. The throttle can also be comprised of an appropriately small line or an appropriately small opening cross section of the check valve. Fundamentally, the connection serves to refill the high-pressure chamber of the pressure intensifier when the pressure intensifier piston is reset.

It is also possible to provide that the differential chamber of the pressure intensifier communicates with the high-pressure chamber of the pressure intensifier by means of a second throttle and a check valve; the check valve unblocks the flow of a fluid from the differential chamber to the high-pressure chamber and the check valve shuts off the flow of a fluid from the high-pressure chamber to the differential chamber. The above-mentioned components consequently fulfill the same purpose as when the low-pressure chamber communicates with the high-pressure chamber. The second throttle can also be eliminated and the differential chamber of the pressure intensifier can be connected to the high-pressure chamber by means of a check valve since an undesirable overflow in the injector produces a pressure difference at the first throttle between the low-pressure chamber and the differential chamber.

The invention is particularly advantageous if the pressure intensifier interrupts a flow connection from the pressure reservoir to the injection nozzle when a particular stroke is reached. This prevents a continuous injection and consequently a destruction of the engine from occurring, for example due to a jamming of the injection nozzle or a jamming of the control valve of the injection nozzle. Preferably, the pressure intensifier piston has a pressure surface, which communicates with the injector supply line even after interruption of the flow connection to the injector. Consequently, the pressure intensifier piston is kept against its end stop in a pressure difference-controlled manner. This means that the corresponding injector is switched off in the event of damage.

It is advantageous if the supply line is closed by means of a sealing device. The two components of the sealing device close the supply line when the pressure intensifier piston has reached its maximal stroke.

However, it can also be advantageous if the filling path is closed by means of a sliding seal. This sliding seal can be constituted by the pressure intensifier piston and by the guide of the pressure intensifier piston. Consequently, the supply line can be closed starting from a particular stroke that depends on the point at which the fluid supply to the high-pressure chamber of the pressure intensifier begins.

Preferably, elastic means are provided for resetting the pressure intensifier piston. These means can be alternatively disposed in the low-pressure chamber, in the differential chamber, in the high-pressure chamber, or in another suitable location. The elastic means can be embodied, for example, in the form of a spring in the low-pressure chamber.

It can also be advantageous to provide at least one separate through flow limiter. According to preferred embodiments of the invention, the pressure intensifier does in fact simultaneously function as a through flow limiter. However, under certain circumstances, it can be useful to use a separate through flow limiter. This component can alternatively be disposed, for example, in the filling path of the high-pressure chamber or between the pressure intensifier and the injector.

It can also be advantageous to provide a two-piece pressure intensifier piston. This permits the second valve unit, which connects the low-pressure chamber of the pressure intensifier to the differential chamber parallel to the throttle, to be eliminated since dividing the pressure intensifier piston prevents an excess pressure in the differential chamber.

According to claim 17, the invention builds on the generic method in that the high pressure is generated by activating a pressure intensifier through opening a valve device, which communicates with a differential chamber of the pressure intensifier and with a return system, and that the through flow quantity of fluid to an injection nozzle is limited. Consequently, a simple actuation of a valve device while avoiding high pressure drop losses can produce a triggering, i.e. an activation or a deactivation, of a pressure intensifier. The through flow quantity limitation prevents a damage to the engine, which could otherwise occur due to a continuous injection in the event of a jamming of the nozzle needle or of the control valve of the injection nozzle.

The method is particularly advantageous if the volume of a high-pressure chamber of the pressure intensifier limits the maximal injection quantity. The pressure intensifier is therefore advantageously used for its primary purpose—pressure intensification—and is simultaneously also used to limit the through flow quantity for inherent safety purposes.

However, it can occasionally also be advantageous if a separate through flow quantity limiter limits the maximal injection quantity. This embodiment, which can also be provided in combination with a through flow limitation of the pressure intensifier, is fundamentally more complicated. A separate through flow limitation, however, can be advantageous with regard to the design of the pressure intensifier.

It is advantageous if the injector is stroke-controlled; it is actually conceivable for the control valve of the injector to be triggered by the same actuator—for example a piezoelectric actuator—as the valve device, which triggers the pressure intensifier. For example, a solenoid valve can also be provided as the actuator in addition to a piezoelectric actuator.

The invention is based on the knowledge that a system with a high degree of inherent safety can be produced using a triggering of a pressure intensifier, without the occurrence of high pressure drop losses. The pressure intensifier can consequently be activated in alternating fashion and the injection course can be shaped. For example, a preinjection can occur at low pressure and a main injection can occur at high pressure. Consequently, for example, an advantageous “boot” shape of the course of the injection pressure can be achieved.

### DRAWINGS

The invention will now be explained by way of example in conjunction with particular embodiments in conjunction with the drawings.

FIG. 1 shows a first embodiment of an injection device according to the invention;

FIG. 2 shows a second embodiment of an injection device according to the invention;

FIG. 3 shows a third embodiment of an injection device according to the invention;

FIG. 4 shows a fourth embodiment of an injection device according to the invention; and

FIG. 5 shows an injection device in order to explain the advantages according to the invention.

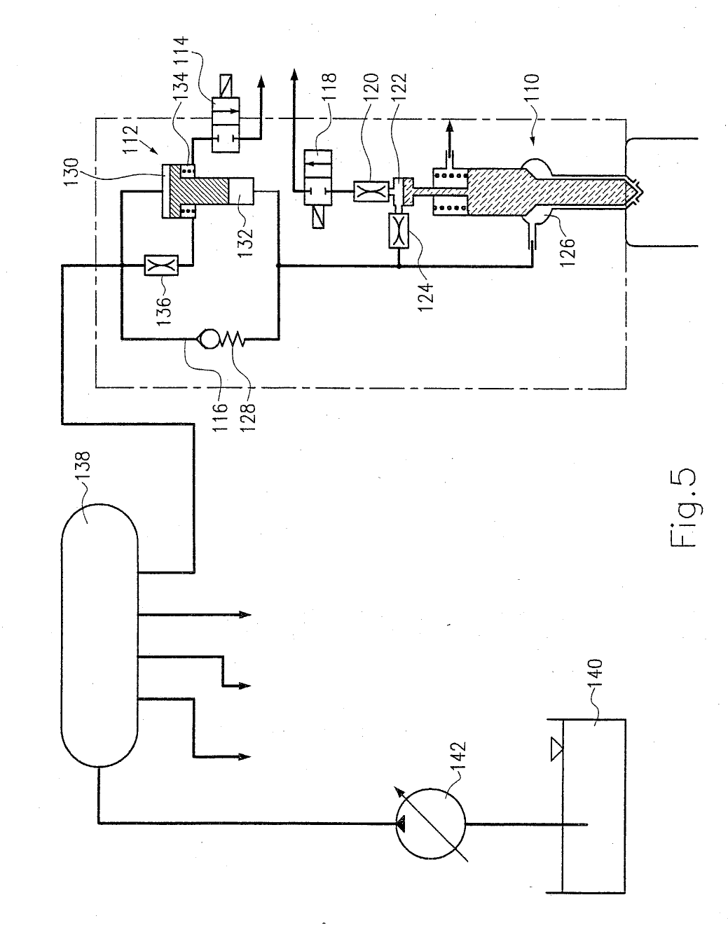

### DESCRIPTION OF THE EXEMPLARY EMBODIMENTS

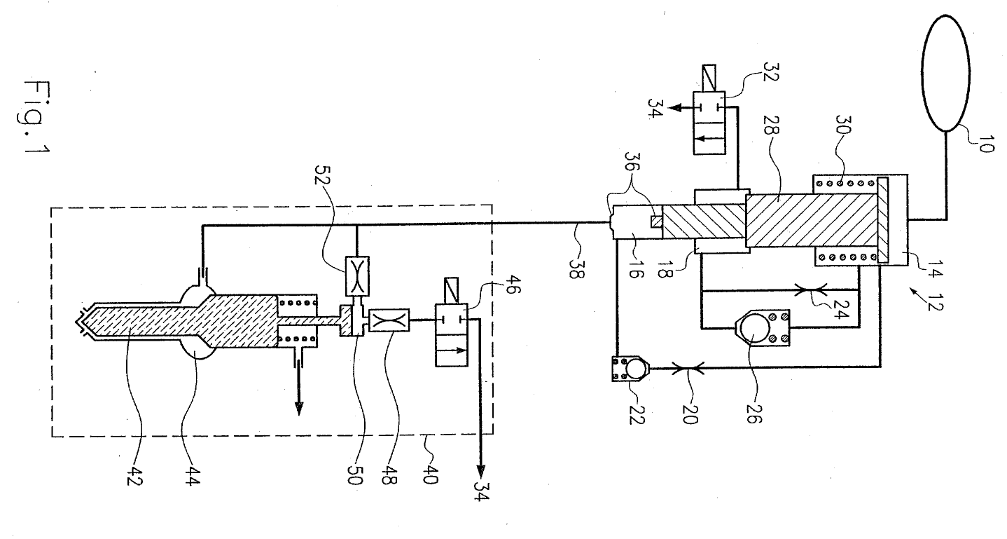

FIG. 1 shows a first embodiment of an injection device according to the invention. A pressure reservoir 10 supplies a primary pressure. This pressure is supplied into the low-pressure chamber 14 of a pressure intensifier 12. In addition to the low-pressure chamber 14, the pressure intensifier 12 has a high-pressure chamber 16 and a differential chamber 18. The low-pressure chamber 14 communicates with the high-pressure chamber 16 by means of a throttle 20 and a check valve 22. The check valve 22 closes in the direction of the low-pressure chamber 14. The low-pressure chamber 14 also communicates with the differential chamber 18 of the pressure intensifier 12 by means of a throttle 24 and a check valve 26 connected in parallel to it. A spring 30 exerts force on the pressure intensifier piston 28 in order to reset it. The check valve 26 closes in the direction of the differential chamber 18.

In order to trigger the pressure intensifier 12, a valve device 32 is provided, which communicates with the differential chamber 18 of the pressure intensifier 12 by means of a connection. The other connection of the valve device 32 communicates with a return system 34. When the valve device 32 is closed, the pressure intensifier piston 28 is pressure-balanced since the rail pressure prevailing in the low-pressure chamber 14 spreads into the differential chamber 18 by means of the throttle 24. The pressure intensifier is deactivated, i.e. no pressure intensification takes place. As a result, an injection at rail pressure is possible. In this connection, the pressure intensifier piston 28 moves downward without pressure intensification, in accordance with the injected quantity. The pressure intensifier 12 thereby functions as a through flow quantity limiter. In particular, the pressure intensifier piston 28 has a valve seat 36 at one end so that when it reaches its maximal stroke, it closes the supply line 38 to the injector 40.

The injector 40 includes an injection nozzle 42 whose pressure chamber 44 communicates with the supply line 38, which is connected to the high-pressure chamber 16 of the pressure intensifier 12. The injector 40 is stroke-controlled; a control valve 46 communicates on the one hand with a return system 34 and on the other hand with a control chamber 50 of the injection nozzle by means of an outlet throttle 48. The control chamber 50 also communicates with the supply line 38 by means of an inlet throttle 52.

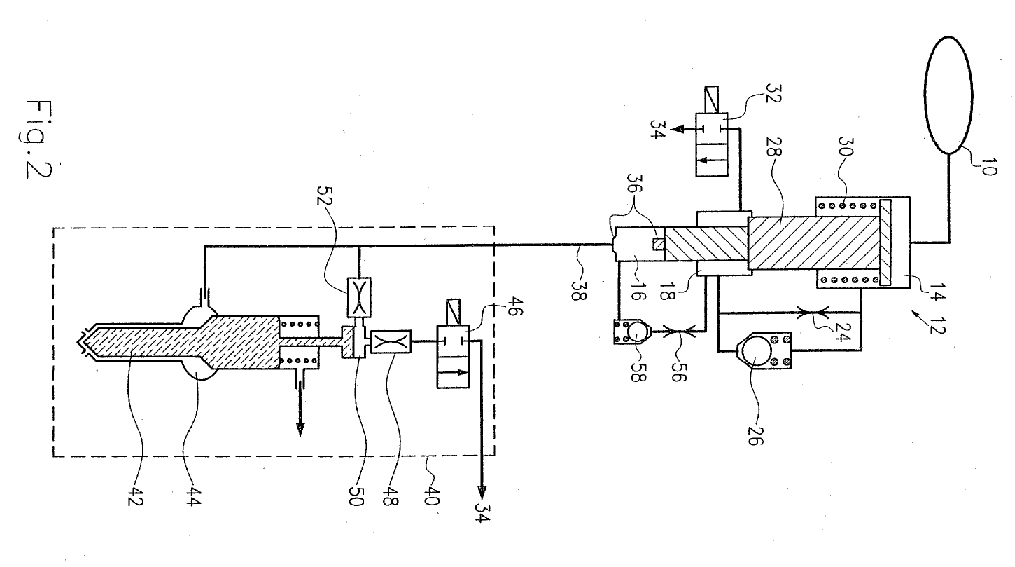

FIG. 2 shows a second embodiment of an injection device according to the invention. In this instance, by contrast with the first embodiment according to FIG. 1, the differential chamber 18 of the pressure intensifier 12 communicates with the high-pressure chamber 16 of the pressure intensifier 12. Consequently, the high-pressure chamber 16 is refilled by means of this filling path. This filling path is also provided with a throttle 56 and a check valve 58 that closes in the direction of the differential chamber 18; these components are connected in series.

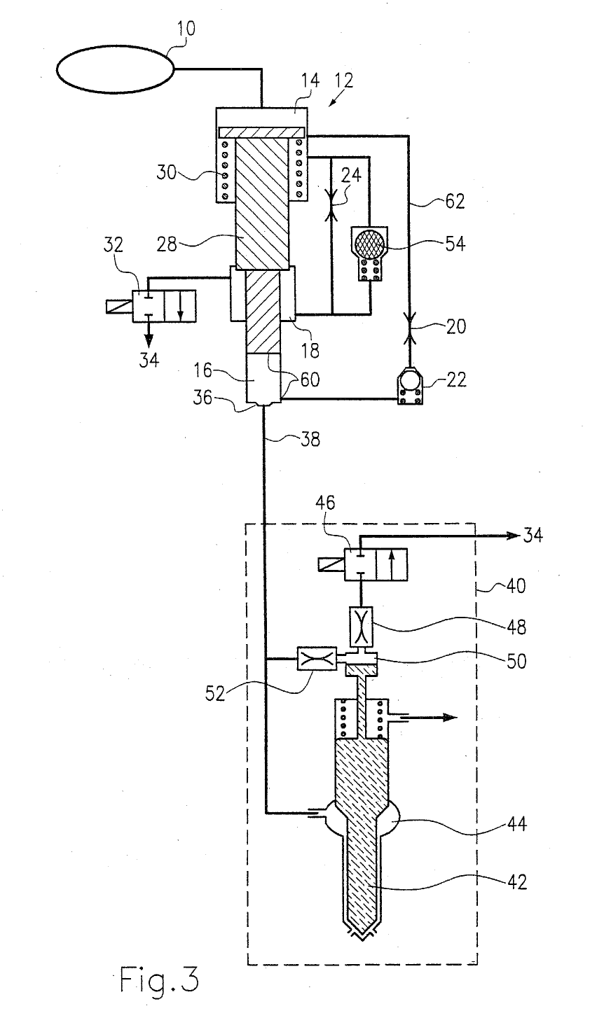

FIG. 3 shows a third embodiment of an injection device according to the invention. This embodiment largely corresponds to the first embodiment shown in FIG. 1. The sealing seat or sealing device 36 (FIG. 1) for closing the supply line 38, however, is replaced by a sliding valve 60 (FIG. 3), which closes off the filling path 62 once the pressure intensifier piston 28 achieves a particular stroke.

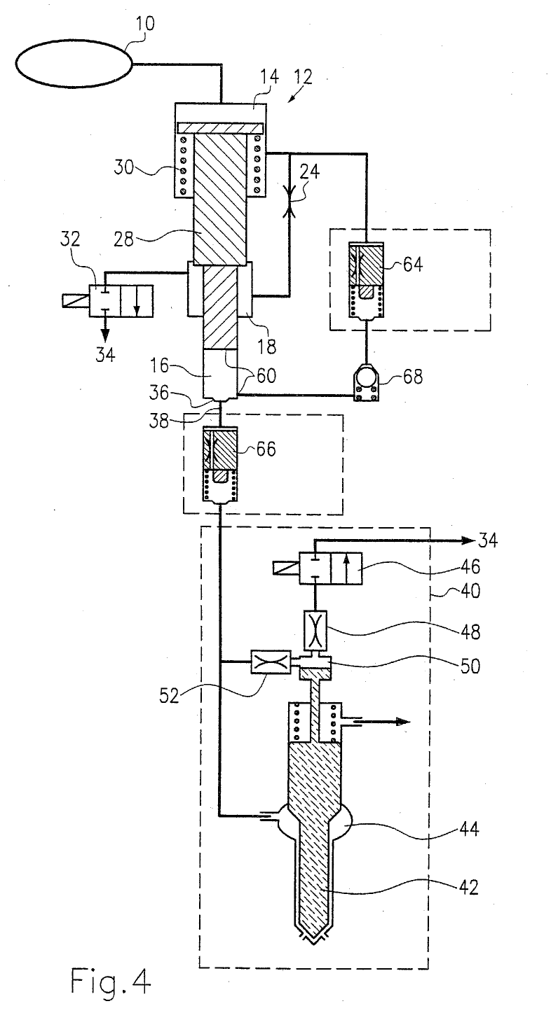

FIG. 4 shows a fourth embodiment of the invention. A separate through flow limiter 64 is provided in the connection between the low-pressure chamber 14 and the high-pressure chamber 18. Alternatively (or in addition), a through flow limiter 66 is disposed in the connection between the high-pressure to 16 of the pressure intensifier 12 and injector 40. If the through flow limiter is disposed in the connection between the low-pressure chamber 14 and the high-pressure chamber 16 of the pressure intensifier 12, then a check valve 68 is once again connected in series with the pressure intensifier 64 in order to prevent a transmission of pressure from the high-pressure chamber 16 into the low-pressure chamber 14.

The foregoing description of exemplary embodiments according to the current invention is intended for illustrative purposes only and is not intended to limit the scope of the invention. Various changes and modifications are possible without going beyond the scope of the invention or its equivalents.

1. An injection device with an injection nozzle (42), a pressure intensifier (12) for intensifying a primary pressure, a first valve device (32) for triggering the pressure intensifier (12), and an actuator for actuating the first valve device (32), characterized in that the pressure intensifier (12) is activated in a first state of the first valve device (32), that the pressure intensifier (12) is deactivated in a second state of the first valve device (32), and that a limitation of the through flow quantity to the injection nozzle (42) is provided.

2. The injection device according to claim 1, characterized in that the pressure intensifier (12) has a low-pressure chamber (14), a high-pressure chamber (16), and a differential chamber (18), that the first valve device (32) communicates with the differential chamber (18) by means of a first connection, that the first valve device (32) communicates with a return system (34) by means of a second connection, and that the first valve device (32) is open in the first state so that the differential chamber (18) communicates with the return system (34).

3. The injection device according to claim 1 or 2, characterized in that the low-pressure chamber (14) of the pressure intensifier (12) communicates with the differential chamber (18) of the pressure intensifier (12) by means of a first throttle (24) and a second valve device (26); the first throttle (24) and the second valve device (26) are disposed in parallel, the second valve device (26) unblocks the flow of a fluid from the differential chamber (18) to the low-pressure chamber (24) and the second valve device (26) shuts off the flow of a fluid from the low-pressure chamber (14) to the differential chamber (18).

4. The injection device according to one of the preceding claims, characterized in that the second valve device is a check valve (26).

5. The injection device according to one of the preceding claims, characterized in that the pressure intensifier (12) closes a supply line (38) to the injection nozzle (42) once a particular stroke has been reached.

6. The injection device according to one of the preceding claims, characterized in that a sealing seat (36) is provided for closing the supply line (38).

7. The injection device according to one of claims 1 to 5, characterized in that a sliding seal (60) is provided for closing a filling path (62).

8. The injection device according to one of the preceding claims, characterized in that the low-pressure chamber (14) of the pressure intensifier (12) communicates with the high-pressure chamber (16) of the pressure intensifier (12) by means of a second throttle (20) and a check valve (22); the check valve (22) unblocks the flow of a fluid from the low-pressure chamber (14) to the high-pressure chamber and the check valve (22) shuts off the flow of a fluid from the high-pressure chamber (16) to the low-pressure chamber (14).

9. The injection device according to one of the preceding claims, characterized in that the differential chamber (18) of the pressure intensifier (12) communicates with the high-pressure chamber (16) of the pressure intensifier (12) by means of a check valve (58); the check valve (58) unblocks the flow of a fluid from the differential chamber (18) to the high-pressure chamber (16) and the check valve (58) shuts off the flow of a fluid from the high-pressure chamber (16) to the differential chamber (18).

10. The injection device according to claim 9, characterized in that the differential chamber (18) of the pressure intensifier (12) communicates with the high-pressure chamber (16) of the pressure intensifier (12) additionally by means of a second throttle (56).

11. The injection device according to one of the preceding claims, characterized in that elastic means (30) are provided for resetting a pressure intensifier piston (28).

12. The injection device according to one of the preceding claims, characterized in that a two-part pressure intensifier piston is provided.

13. The injection device according to one of the preceding claims, characterized in that at least one pressure intensifier piston controls a flow connection to an injector (40).

14. The injection device according to claim 13, characterized in that when disposed in its end position, the pressure intensifier piston interrupts a flow connection to the injector (40).

15. The injection device according to one of the preceding claims, characterized in that at least one separate through flow quantity limiter (64, 66) is provided.

16. The injection device according to one of claims 1 to 14, characterized in that the pressure intensifier (12) provides the through flow quantity limitation.

17. A method for injecting fluid, in which in a first phase, an injection takes place at a low pressure and in a second phase, an injection takes place at a high pressure, characterized in that the high-pressure is generated by activating a pressure intensifier (12) through opening a valve device (32), which communicates with a differential chamber (18) of the pressure intensifier (12) and with a return system (34), and that the through flow quantity of a fluid to an injection nozzle (42) is limited.

18. The method according to claim 13, characterized in that the volume of a high-pressure chamber (16) of the pressure intensifier (12) limits the maximal injection quantity.

19. The method according to claim 13 or 15, characterized in that a separate through flow limiter (64, 66) limits the maximal injection quantity.
